(19) United States
(12) Patent Application Publication
(10) Pub. No.: US 2009/0196956 A1
(43) Pub. Date: Aug. 6, 2009

(54) LOW GLYCEMIC FROZEN CONFECTION

(76) Inventor: Ann de Wees Allen, St. Petersburg, FL (US)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/366,251

(22) Filed: Feb. 5, 2009

Related U.S. Application Data
(60) Provisional application No. 61/026,345, filed on Feb. 5, 2008.

(51) Int. Cl. A23G 3/42; A23G 3/34; A23G 3/46

(52) U.S. Cl. 426/72; 426/660; 426/74; 426/519

(57) ABSTRACT

Frozen confections having a combination of ingredients that provide outstanding organoleptic properties while at the same time ensuring a low glycemic product for consumption. In one aspect, the invention provides a frozen confection that comprises a natural nutritive sweetener, wherein the sweetener comprises kiwi, at least one glycoside, and at least one carbohydrate. The subject frozen confection is particularly advantageous because it does not significantly stimulate lipoprotein lipase (LPL), the fat storing enzyme. Moreover, the subject frozen confections are pleasing in taste, mouth-feel, and other organoleptic qualities without the use of artificial sweeteners or sucrose or high glycemic sugar.

### CROSS-REFERENCE TO A RELATED APPLICATION

This application claims the benefit of U.S. provisional application Ser. No. 61/026,345, filed Feb. 5, 2008, which is incorporated herein by reference in its entirety.

### FIELD OF THE INVENTION

Low glycemic frozen confection products for consumption having a combination of ingredients that provide outstanding organoleptic properties while at the same time triggering little or no cephalic phase insulin response in humans, and is acceptable for Type 1 and Type 2 diabetic adult and children diets.

### BACKGROUND OF THE INVENTION

The problem of weight control, in particular minimization of the accumulation of fat, has long been an issue of concern for people. Conventional dieting employing caloric restriction has been shown to be inconsistent, at best, for weight control. When receiving insufficient calories, the human body experiences fatigue, immune suppression, increased fat cell storage, and depression. In addition, statistics have shown that 95% of all persons who diet gain back most of the lost weight within one year.

The urge to eat is rooted in the brain's genetic-survival program and cannot be ignored. Successful weight control depends on four important factors: sufficient caloric intake; balanced blood sugar levels; proper nutrient intake; and taste satisfaction with the food consumed. If any one of these factors is ignored, weight control is less than optimal.

Obesity is becoming a global epidemic. Obesity is now so common within the world's population that it is beginning to rank with infectious diseases and malnutrition as one of the most significant contributors to ill health. Obesity is associated with diabetes mellitus, certain forms of cancer, sleep-breathing disorders, and coronary heart disease. There remains a long-felt need in the art for a method of weight control that is convenient and yet can maintain its beneficial effects for a long period of time.

Despite the proven medical risks associated with weight gain, the obesity rate continues to grow at an alarming rate. The Center for Disease Control (CDC) reported that the number of people considered obese increased from 12% in 1991 to 17.9% in 1998. According to the New England Journal of Medicine. 58 million people in America are obese.

Factors that play a role in the development of obesity also include insulin growth hormone, lipoprotein lipase (LPL), leptin, ventromedial hypothalamic lesions, endogenous opioid peptides, norepinephrine, epinephrine, serotonin, density of alpha-2 adrenergic receptors, genetics, caloric intake, dietary ratios of protein-to-carbohydrates-to-fat, and exercise. Perhaps the most influential determinate of the fat-storing pathway of consumed food is LPL.

LPL is an enzyme which hydrolyzes plasma triglyceride into free fatty acids (FFA) and glycerol, and works for the uptake of plasma triglyceride by the tissue. Adipose tissue LPL permits uptake of plasma triglyceride as storage in fat cells, while muscle LPL utilizes plasma triglyceride as fuel for muscle. Consequently, adipose tissue LPL is very important for fat accumulation. Insulin increases adipose tissue lipoprotein lipase (LPL) activity, and LPL increases the burning of fat in muscle cells.

There is a direct correlation between plasma LPL activity and insulin levels, but muscle LPL activity is not insulin dependent. In sports nutrition, body builders and other athletes utilizing insulin as a means of increasing muscle mass are actually programming the body to store fat as opposed to building muscle mass.

When high glycemic carbohydrates and/or sugars (i.e., those that trigger increased secretion of insulin) are eaten and/or insulin is secreted via the cephalic phase insulin response (CPIR), the result is stimulation of LPL. This enzyme sends the message to store food in the rat cells. Consequently, ingestion of high glycemic foods can result in accumulation of excess adipose tissue (body fat). High glycemic foods are the least abundant foods found in the natural human food chain. Conversely, due to present day industrialized food production, high glycemic foods have become the most abundant form of food.

Since many Americans are either overweight or obese, it is inevitable that a large percentage of the population will eventually develop diabetes. With dietary intervention, this can be prevented. Insulin is stimulated by ingestion of high glycemic foods and drinks. Low glycemic, non-CPIR triggering foods are converted into glucose more slowly than high glycemic, CPIR triggering foods, so the lower the glycemic index and CPIR of the food, the less insulin is required to control blood sugar. In order to control insulin elevated by dietary factors, the glycemic response of all foods and drink needs to be factored into the dietary equation.

Various sweeteners are known in the art. Monosaccharides, the simplest carbohydrates, are aldehydes or ketones having two or more hydroxyl groups, having the empirical formula (CH₂O)ₙ. Monosaccharides having an aldehyde functional group are known as aldoses while those having a ketone functional group are ketoses. A sugar having six carbon atoms is called a hexose. Common hexoses include fructose (a ketose) and glucose (an aldose). A disaccharide consists of two sugars joined by an O-glycosidic bond. Three highly abundant disaccharides are sucrose, lactose, and maltose. Sucrose (common table sugar) is obtained from cane or beets.

Until the proliferation of artificial chemical sweeteners, sucrose and honey were the most commonly used sweeteners. These sugars, however, cause an imbalance in insulin levels, thereby causing energy and mood swings, and stimulating cravings for sweets. As compared to other sweeteners, sugar and honey not only increase the urge for more sweets and carbohydrates, but also stimulate the pancreas to secrete large amounts of insulin and triggering increased LDL and fat storage.

Because of the fat-storage effects of sucrose and honey, many food manufacturers concerned with health have switched to glucose and glucose polymers. Glucose is a crystalline sugar also found in fruits and honey. However, glucose also causes the release of a large amount of insulin.

Frozen confections, such as ice cream, water ice, sherbet and the like, have long been popular among children and adults alike. Formulators of frozen confections and related products, as well as academics and others, have attempted to provide products having fewer calories and/or lower levels of fat. Unfortunately, many of these formulations do not possess the same organoleptic properties (such as taste and texture) as those found in non-adulterated frozen confections (which typically have superior taste and greater amounts of calories and fat).

Rothwell, Ice Cream and Frozen Confectionery, 1985, 36 (9) 442, 450-451, describes the historical development of diabetic and dietetic ice creams. Use of polydextrose as bulking agent is discussed. One of the basic mixes includes 4% fat (either milk or non-milk fat), 15% polydextrose, 0.5% microcrystalline cellulose, 0.2% sodium citrate, 11.3% milk SNF, 0.75% stabilizer/emulsifier, and 0.75% aspartame.

U.S. Pat. No. 3,800,036 is directed to frozen desserts including ice milk and imitation ice cream having optionally up to 7 wt. % fat. Sugar may be included and an inert bodying material such as dextran, inulin or microcrystalline cellulose may be substituted for sugar when artificial sweeteners are used. Other possible ingredients are fructose, dried egg white and starch. Various frozen confection formulations are provided.

Silhouette® Low Fat Ice Cream Sandwich (vanilla/mint flavors), said to be 98% fat free, lists the following ingredients: nonfat milk, sugar, corn syrup, cellulose gel, locust bean gum, mono and diglycerides, guar gum, cellulose gum, polysorbate 80, carrageenan, natural vanilla flavoring and cocoa (apparently for a chocolate variant). The ingredients listed for the wafers are: bleached wheat flour, soybean oil, caramel color, corn sugar, cocoa, high fructose corn syrup, modified corn starch, salt, baking soda and soy lecithin. Strawberry, coffee and mint flavors are said to contain all natural extract (Mint extract contains FD&C yellow #5, FD&C Blue #1, sodium benzoate, potassium sorbate and citric acid. The % daily value indicated on its label for vitamin A was 0%, calcium was 8%, vitamin C was 0% and iron was 0%.

At least as of Oct. 31, 2002, Atkins chocolate shake mixes are disclosed on the Carbsmart website to include tricalcium phosphate, polydextrose, whey protein isolate, and various vitamins.

Berry, “From Showcased Ingredients to the Dairy Case,” Dairy Foods September 2002, mentions tricalcium phosphate among tasteless calcium salts. The article also mentions Luke's Ice Cream of Riviera Beach, Fla. as manufacturing Sugar Free Fat Free Frozen Treat made using delactosed non fat milk, polydextrose, maltodextrin, and sucralose. It also indicates that for many “better for you frozen desserts,” bulking agents such as polydextrose and maltodextrin are necessary. It has a neutral taste, is highly soluble and has fiber properties.

U.S. Pat. No. 5,292,544 is directed to low fat, very low fat or fat free emulsion simulating food products prepared by adding tricalcium phosphate to develop an opaqueness and smoothness in the food, and to reduce gloppiness in foods containing gum, especially xanthan. Use in ice cream and ice milk products is mentioned. Locust bean gums, starches, starch maltodextrin and cellulose gels are mentioned. Example 8 is directed to a fat free shake including tricalcium phosphate, corn syrup solids and xanthan gum.

U.S. Pat. No. 5,456,936 is directed to a substantially lactose- and sugar-free, low calorie frozen confection having a 20% to 100% overrun. Gums wvlhich can be used are said to include locust bean gum, carrageenan, xanthan gum, guar and carboxymethyl cellulose. Cellulose gel can be used as a stabilizer. Among the bulking agents mentioned are polydextrose, maltodextrose, sugar alcohol or starches.

Despite the appearance of a plethora of “healthy” variants of numerous types of frozen confections, it seems clear that many consumers are not willing to sacrifice the organoleptic properties of their favorite indulgence because of some imaginable health benefit in the future. Thus, a developer of frozen confections faces the formidable challenge of providing products that continue to have outstanding organoleptic properties while at the same time reducing the caloric impact for those consumers who would benefit from assistance in losing weight.

Cephalic Phase Insulin Release: Research has shown that in human subjects, as well as in animals, taste stimuli can elicit insulin secretion by the beta cells of the pancreas. This early increase of insulin secretion following gustatory stimulation is of cephalic origin and is commonly referred to as cephalic phase insulin release (CPIR). Typically, plasma insulin concentrations increase within two minutes after oral stimulation, reach their maximum at 4 minutes and return to baseline within 10 minutes. Essentially, when we taste a food that triggers CPIR (i.e., nutritive sweeteners such as sucrose), the brain immediately engages the biochemical apparatus of the body to get ready for anticipated carbohydrate consumption by increasing insulin secretion.

The intake of sweeteners (such as sucrose) has increased markedly in the United States and globally over the past few decades, coincident with the increased incidence and prevalence of overweight and obesity. Accordingly, recommendations were presented to moderate intake of nutritive sweeteners. One approach to limiting sweetener intake is to substitute artificial sweeteners for nutritive sweeteners in digestible products. Other recommendations include ingesting low-fat and fat free products and/or consuming low carbohydrate products. Yet even after the instigation of such remedies, the one constant over the last few years has been a continued steady increase in the rates of obesity among both the adult and pediatric populations in the United States and throughout the industrialized countries.

Recent experiments have shown that certain taste modalities such as “sour,” “salty,” “bitter,” and “starch” fail to produce CPIR whereas artificial sweeteners such as saccharin and sweeteners such as sucrose both elicit CPIR in rats. These experiments suggest that before any sugar molecules are actually absorbed into the blood stream, the brain is sending the message to the pancreas to secrete insulin. Thus, the body will be set up for fat storage, even if the sweet taste is caused by an artificial sweetener with fewer calories attached. Unfortunately, because the secreted insulin drives down the circulating blood sugar and drives up the hunger signals, a person whose CPIR is triggered by an artificial sweetener will ultimately crave more calories. Thus, if many synthetic sweeteners currently on the market stimulate CPIR, resulting in secretion of insulin and fat storage, it is no wonder that individuals who are attempting to lose weight by consuming synthetic sweeteners are unable to do so, perhaps even contributing to further weight gain.

Glycemic Index: Glycemic researchers rank carbohydrates and sugars according to their ability to break down into glucose and enter the bloodstream, thus triggering insulin to be released. This ranking system is called the “glycemic index.” The glycemic reaction of mixed meals, prepared foods, packaged foods, or foods containing multiple ingredients is called the “glycemic response.”

When carbohydrates, including sugars, are ingested in humans they are converted into glucose. In response to the glucose entering the bloodstream, the pancreas releases insulin. The insulin then transports the glucose-sugar into muscle cells and the liver for later use as an energy fuel. Certain carbohydrates, namely high glycemic carbohydrates, break down very rapidly in the digestive tract, sending an excess amount of glucose into the bloodstream. When that happens, the pancreas responds by sending out large amounts of insulin to handle the load.

All sugars, carbohydrates, and foods have a glycemic response in the body. Glucose has a glycemic index of 100, which creates a significant rise in blood sugar and insulin. Dextrose, maltodextrins, sucrose (table sugar), honey, high fructose corn syrup, and many other carbohydrates and sugars are commonly used in foods and drinks. These sugars/carbohydrates are also high glycemic and can cause the following negative responses in the body:
Elevation of blood sugar
Elevation of insulin
Increased risk of diabetes
Stimulation of fat-storage and size of fat cells

The average American's diet contains an abundance of high glycemic foods. Consistent consumption of high glycemic foods causes an excess of insulin levels in the body. Excess insulin exacerbates insulin resistance. It is currently estimated that one-fourth of all Americans are insulin-resistant. Insulin resistance causes muscle cells to lose sensitivity to insulin, thus requiring higher and higher amounts of insulin to be released in order to meet the demands of the incoming glucose.

When the pancreas is able to keep up with the demand, insulin resistant persons stay in relative balance, with weight gain and lethargy as a side effect. When the pancreas cannot cope with the strain, blood glucose abnormalities are often a result. It is important for persons with blood sugar imbalances to pre-determine the glycemic response of a food, meal, sugar or sweetener prior to consuming it.

Muscle Glycogen. Carbohydrates that are stored in the body's muscle tissue are referred to as muscle glycogen. Muscle glycogen is essential in sports performance, endurance, and the conversion of fat to energy. The more muscle glycogen available during sustained exercise, the greater the potential for improved endurance. Sustained exercise requires available muscle glycogen.

Different sugars have different effects on muscle glycogen depletion rates. Glucose and other high glycemic sugars and carbohydrates like maltodextrins, provide a quick spurt of energy. This triggers the release of insulin and increases the depletion of muscle glycogen. This negative biochemical chain reaction also suppresses the conversion of fat to energy, which can cause an athlete to “hit the wall.” In the average person it causes stimulation of fat-storage, increased size of fat cells, weight gain, lack of energy, blood sugar swings and exacerbation of development of diabetes and other blood sugar disorders.

Unlike high glycemic sugars and carbohydrates, low glycemic sugars and carbohydrates do not cause a rapid rise in either blood sugar or insulin. Low glycemic carbohydrates/sugars help energy stores in the muscles last longer, thus increasing the potential for greater endurance during exercise. Low glycemic sports drinks taken prior to exercise result in a much lower rate of muscle glycogen depletion. Sports drinks and drinks made with high glycemic carbohydrates and/or sugars can reduce sports performance. Low glycemic sugars/carbohydrates can be used in place of high glycemic sugars to help alleviate muscle glycogen impairment during athletic events.

Glycosides. Glycosides are sugar derivatives providing intense sweet taste, and in some cases, a bitter taste. Glycosides are water soluble compounds which can be found in certain plants, legumes, Chinese teas, and fruit. Glycosides are broken down into sugars (including glucose) by enzymes. A “glucoside” is a glycoside that yields glucose.

Glycosides contain a carbohydrate portion (glycone) and a non-carbohydrate portion (aglycone). Based upon the chemical nature of the aglycone portion, glycosides can be placed into the following twelve basic categories:

Glycoside Classifications:

Tannins

Cardioactives

Aldehydes

Anthraquinones

Alcohols

Saponins

Lactones

Cyanophores

Isothiocyanates

Phenols

Flavonals

Natural sweet glycosides range in sweetness up to 425 times sweeter than sucrose, with a molecular weight of 250 to 1000.

Kiwi Fruit. There is no known toxicity related to kiwi fruit, and it is considered to be a beneficial fruit. In clinical studies, kiwi fruit has been shown to limit symptoms of asthma and other respiratory disorders. In a study of 18,737 children, a higher intake of kiwi fruit and vitamin-C rich citrus fruit diminished shortness of breath, chronic and nocturnal cough, non-coryzal rhinitis, and wheezing (Thorax [April 2000] 55(4):283-288).

According to the U.S. Food and Drug Administration, Center for Food Safety and Applied Nutrition, SN/AEMS report on adverse health problems reported to the FDA, related to foods, food ingredients, and nutrients, there is no report of any negative health effect associated with or directly related to ingestion of kiwi.

Despite its safety profile, kiwi fruit has been typically eliminated from being used in any sweetener formula or product due to its conflicting enzymatic activity when in contact with yogurt, yogurt cultures, frozen yogurt, and any product containing yogurt, yogurt cultures, or yogurt enzymes. “Kiwi fruit cannot be blended with yogurt because an enzyme conflicts with the yogurt process” (Department of Horticulture, Purdue University, January 2001; page 10; Morton, J. [1987] Kiwifruit, pp 293-300).

To date, there are no frozen confections available that include a low glycemic sweetener comprising a glycoside and kiwi fruit, where the sweetener triggers little or no CPIR. In fact, despite the appearance of a plethora of “low calorie/low fat/healthy” variants of frozen confections, many consumers are not willing to sacrifice the organoleptic properties (such as taste and texture) of non-adulterated frozen confections. There is accordingly a need for a frozen confection that continues to have desired organoleptic properties while at the same time providing low glycemic, non-CPIR triggering ingredients.

### BRIEF SUMMARY

The present invention provides low glycemic, non-CPIR triggering frozen confections having a combination of ingredients that provide outstanding organoleptic properties (such as taste, smell, sight, etc.) while at the same time reducing caloric impact without significantly stimulating lipoprotein lipase (LPL) and/or elevating insulin levels.

Preferably, the low glycemic non-CPIR triggering frozen confections of the invention do not elevate blood glucose or insulin to levels normally observed with frozen confections made with sugar or high fructose corn syrup. The low glycemic non-CPIR triggering frozen confections of the invention are particularly advantageous because they do not activate human fat-storage in adipose tissue fat-cells via lipoprotein lipase and they do not imbalance leptin levels.

In certain embodiments, the frozen confection includes a dairy source, which will generally contribute dairy fat. In other embodiments, the frozen confection includes a pureed fruit product.

In one embodiment, the subject invention provides a frozen confection that consists essentially of a nutritive sweetener comprising kiwi fruit, a glycoside, and a carbohydrate derived from fruit. The nutritive sweetener preferably does not induce over elevation of blood glucose or insulin levels upon ingestion.

In preferred embodiments, at least about 0.1% to 20% of a nutritive sweetener is used in the frozen confections of the invention, wherein the sweetener is a low glycemie sweetener composition that consists of kiwi powder, cucurbitane glycoside, and fruit sugar (also known as fructose). More preferably, the low glycemic sweetener is metabolized via metabolic processes associated with the breakdown of low-glycemic fruit. For example, the low glycemic sweetener does not stimulate lipoprotein lipase (LPL) or imbalance leptin levels. Further, because the low glycemic sweetener does not stimulate LPL, it does not activate fat-storage in adipose tissue fat cells.

In certain embodiments of the invention, in addition to the nutritive sweetener, the frozen confection is fortified with one or more vitamins and/or minerals and/or fibers, thus improving the health profile of the product.

The frozen confections of the subject invention combine desirable organoleptic properties while avoiding the use of high glycemic, insulin-stimulating sugars and sweeteners.

The frozen confections of the invention are acceptable for use by dieters. In fact, the subject frozen confections can be used for preventing or treating excess weight gain (such as obesity). The frozen confections of the invention are also acceptable for use by any individual who wishes to partake, including children, Type I and Type II diabetic children, Type I and Type II adult diabetics, obese persons, overweight persons, persons with Insulin Resistance, hypoglycemics, athletes, and health conscious individuals.

Advantageously, the frozen confections described herein do not stimulate resisten. In individuals with Type II diabetes, the frozen confections of the present invention decrease the glucose and insulin responses to the Oral Glucose Tolerance Test (OGTT). In normal subjects, especially those with the poorest glucose tolerance, the present invention aids in improving glucose tolerance

### DETAILED DISCLOSURE OF THE INVENTION

The product of the invention is a frozen confection, such as ice cream, sherbet, water ice, frozen yogurt, and the like. “Frozen,” as used herein, denotes that the product is solidified under freezing conditions to a hardpack or spoonable consistency, which can be fluid or semi-fluid when exposed to room temperatures (such as a milk shake or other beverage). The frozen confection may be combined with other ingredients such as wafers in an ice cream sandwich or an appropriate sauce in a sundae. The frozen confection is preferably a water-continuous emulsion.

The frozen confection of the invention comprises a natural, low glycemic, low calorie, nutritive sweetener, wherein the sweetener consists essentially of kiwi, at least one glycoside, and at least one carbohydrate. The subject frozen confection is particularly advantageous because it does not significantly stimulate lipoprotein lipase (LPL), the fat storing enzyme, nor does it imbalance leptin levels in subjects. Moreover, the subject frozen confections are pleasing in taste, mouth-feel, and other organoleptic qualities without the use of artificial sweeteners or sucrose or other any other high glycemic sugar.

In one embodiment, the amount of the nutritive sweetener is a composition that consists of kiwi powder, cucurbitane glycoside, and fruit sugar, which is present in the frozen confection of the invention from about 0.1% to about 20%.

In one embodiment, the subject invention provides a novel frozen confection that includes TRUTINA DULCEM® as the nutritive sweetener. TRUTINA DULCEM (TD) is described in U.S. patent application Ser. Nos. 10/458,125 and 12/204,183, both of which are incorporated herein by reference in their entirety, including all figures and tables. TD does not elevate blood glucose levels, nor does it overly elevate insulin levels. Therefore, TD is ideal for most diabetics, hypoglycemics, as well as patients requiring intravenous fluid therapy. Unlike sucrose or dextrose, TD is a low glycemic nutritive sweetener.

Preferably, the nutritive sweetener of the invention (such as TD) comprises compounds that the body synthesizes and metabolizes. The metabolic process for the nutritive sweetener is the same as the process for any low glycemic natural fruit, such as peaches, pears, apples, and oranges. The nutritive sweetener of the invention is re-sorbed more slowly than glucose and other sweeteners; it is more slowly absorbed by facilitated diffusion from the gastrointestinal tract than glucose and other sweeteners,

Everything that animals consume has an effect on blood sugar. Foods that overly elevate blood sugar levels (such as many frozen confections) trigger an excessive-secretion of insulin, and insulin is a precursor of lipogenesis (fat storage). Aside from promoting fat storage, insulin peaks also cause low blood sugar which can set off eating binges. Thus, the low glycemic frozen confections of the subject invention, which do not over-elevate blood sugar and insulin levels, are desirable for weight control and for maintenance of good health.

In addition to providing a broad range of health benefits, the frozen confections of the present invention can also be used to control appetite. False cravings for food are most often caused by low blood sugar. Humans need to eat every three hours to keep blood sugar levels properly balanced. Blood sugar levels account for energy as well as level of mental function. In the past, humans consumed small portions of food throughout the day. As a result, the human body continues to function more efficiently when fed every few hours. When one does not eat frequently enough, the result is tiredness, weakness, inability to focus and, as a result of improper eating habits, weight gain eventually results. In our busy society, eating every few hours, however, is not possible. The composition of the present invention thus provides carbohydrates needed by the body to stop the blood sugar from plunging.

Unlike most frozen confections, those of the present invention have little effect on blood sugar levels, as the liver converts the nutritive sweetener (such as TD) to glucose over an extended period of time. Advantageously, the compositions of the present invention act, metabolically, like a time-release carbohydrate, thus eliminating insulin-spillover. This provides a preferred frozen confection for diabetics and hypoglycemics. The frozen confections described herein may also be used as a diet aid due to these factors.

Obese individuals (who do not have diabetes) typically have normal blood sugar levels and elevated insulin levels (in fasting and fed states). Obesity causes certain tissues in the body to be less sensitive to insulin, and this insulin resistance is one of the main features of type II diabetes. Continual high insulin levels lead to diabetes.

A protein-hormone produced by fat cells (adipocytes), called resisten, has been identified as providing a link between diabetes and obesity (Flier, Jeffrey S. [2001] “Diabetes: The Missing Link with Obesity?” Nature 409:292-293). Resisten suppresses insulin's ability to stimulate Glucose uptake into adipose fat cells. Insulin-stimulated glucose uptake by adipocytes is enhanced by neutralization of resisten and is reduced by resisten treatment (Steppan et al. [2001] “The hormone resisten links obesity to diabetes” Nature 409:307-312).

In a preferred embodiment, the frozen confections of the subject invention can be used to diminish the concentration and/or effects of resistin. This neutralization of resistin activity reduces the proclivity towards, and/or effects of, Type II diabetes and helps to control and/or prevent obesity.

### Nutritive Sweetener

The nutritive sweetener of the invention preferably consists essentially of: (a) kiwi fruit, (b) at least one natural fruit glycoside, and (c) at least one low glycemic carbohydrate from fruit. Preferably, the nutritive sweetener consists of kiwi powder, cucurbitane glycoside, and fruit sugar. The nutritive sweetener is to be used in place of glucose, sucrose, fructose, corn syrup, lactose, maltose, galactose, aspartame, saccharine, sucralose, and other natural or artificial sweeteners generally used in frozen confections. The nutritive sweetener is preferably at least 2X sweeter than sucrose; more preferably at least 5× sweeter than sucrose; even more preferably at least 10× or 15× sweeter than sucrose.

The kiwi flavor is subacid to quite acid, which advantageously matches well with glycosides used according to the present invention. The fruit's special sweetness with a delicate citrus character and a hint of strawberry and pineapple also provides flavor and sweetener characteristics to the present invention.

Chinese kiwi fruit is preferred in the practice of the present invention. New Zealand kiwi fruit is the second choice, and California kiwi fruit, the third choice. There are four main Chinese classes of kiwi fruit:
Zhong Hua
Jing Li
Ruan Zoa
Mao Hua

The polysaccharides in kiwi fruit are categorized as carbohydrates and are one of a group of carbohydrates that upon hydrolysis yield more than two molecules of simple sugars. They are complex carbohydrates of high molecular weight, usually insoluble in water, but when soluble, they form colloidal solutions. They include two groups: starch and cellulose. The hemicelluloses include the pentosans (e.g. gum Arabic), hexosans (e.g. agar-agar), and hexopentosans (e.g. pectin).

The present invention overcomes the significant problems associated with using kiwi fruit in a sweetener/carbohydrate product. The sweetener compositions described herein have none of the negative side-effects typically associated with kiwi and kiwi products. Advantageously, these compositions can be used in conjunction with yogurt and yogurt by-products without any conflicting enzymatic activity.

Preferably, the frozen confections of the invention include a nutritive sweetener that contains glycosides derived from fruit. In certain embodiments, the glycosides of the present invention comprise triterpene and/or other terpene glycosides. Contemplated triterpene and terpene glycosides include the following: sweet diterpenoid glycosides compounds; ent-Kaurene type glycoside compounds; Dulcoside A, Rebaudioside A-E. Stevioside, Rubusoside, Suavioside A, B, G, H, I, J, and Steviol 13-O—O—D-glucoside (or Steviolmonoside), Labdane type glycoside compounds; Baiyunoside, Gaudichaudioside A, and Phlomisoside-I; Sweet Triterpenoid glycoside compound; Cycloartane glycosides; Abrusosides A-D; Oleanane glycosides type; Glycyrrhizin, Apioglycyrrhizin, Araboglycyrrhizin, and Periandrin I-V; Cucurbitane glycosides; Siamenoside I, Mogroside W, V, and 11-Oxomogroside V; Secodammarane glycosides; Pterocaryosides A, B; Dammarane; and Gypenoside XX.

These natural sweet triterpene and terpene glycoside compounds can be extracted from roots, leaves, plants, legumes, and fruit.

Compounds of sweet triterpenoid glycosides are based on five distinct triterpene carbon skeletons, and accordingly divided into five types as listed above. Some of these triterpene glycosides, for example a number of dammarane and oleanane types triterpenoid glycosides, are “antisweet” or “sweetness-enhancing” as determined by their sweetness-inhibitory/enhancing (or sweetness-modifying) properties.

Several sweet terpene glycosides are extensively used as flavoring agents. A labdane diterpene arabinoside (gaudichaudioside A) was found to exhibit sweet properties, unlike most glycosides from species in the same genus. However, for purposes of the present invention, arabinosides are not preferred. These sweet terpenes include, but are not limited to, Phyllodulcin, Glycyrrhizin, Rebaudioside A, Stevioside, and Thaumatin.

Methods for obtaining glycosides from fruit are well known in the art and are described in, for example, U.S. Pat. Nos. 5,411,755; 4,084,010; 6,103,240; and 6,124,442. These methods generally include one or more extraction and/or concentration steps.

As a further component, or as a substitute for a naturally occurring glycoside, the nutritive sweetener of the subject invention can optionally include one or more semi-synthetic or wholly synthetic glycoside analogs. Examples of such glycoside analogs include, but are not limited to, modified ent-kaurene diterpenoid glycosides, modified labdane diterpenoid glycosides, modified cycloartane triterpenoid glycosides, and modified oleanane triterpene glycosides. An analog of rebaudioside A has been synthesized, having (sodiosulfo)propyl group at C-19 in place of the 10-O-β-D-glucosyl moiety of the natural product (Dubois, G. E. et al. [1984] J. Agric. Food Chem. 32:1321-1325).

In a preferred embodiment, the nutritive sweetener comprises a fruit sugar. Fructose is commonly called “fruit sugar” because of its widespread occurrence in fruits. Fructose may exist as either of two stereoisomers, designated as either D-fructose or L-fructose. The L-fructose form is preferred in the practice of the present invention. L-fructose is a ketohexose and its molecular formula is C₆H₁₂O₆.

Fructose supplies relatively consistent energy levels with minimal or no stimulation of insulin production. Sugar (sucrose), honey, glucose and many common carbohydrates supply energy but they also stimulate insulin production. This causes rebound tiredness and fat gains. By contrast, fructose which is used in the present frozen confection remains in the intestinal tract for a longer period of time than regular sugars or carbohydrates. This provides for a type of time-released energy and therefore relatively consistent levels of energy production result.

The amount of fructose in the nutritive sweetener of the present invention is an effective amount to achieve the desired effect of the present invention, i.e., to work along with the other components present in the frozen confection in order to provide a product with a low glycemic index. The amount of fruit sugar in the nutritive sweetener generally ranges from about 2 to 20 grams per serving, preferably about 3 to 12 grams per serving, and more preferably about 5 grams per serving. A serving usually represents about six to twelve ounces.

### Avoidance of Toxicity

Since the present invention is a frozen confection to be consumed, the exclusion of toxic and potentially toxic glycosides is essential. Though several of the glycosides listed above are acceptable as sweetening agents, their toxicity, potential toxicity, and side-effects eliminate their inclusion in the present invention.

For example, dextrose substitutes derived from fruits and plant containing glycosides such as Licorice (Glycyrrhiza glabra), and extracts of Licorice, arc considered to be inappropriate for use in the frozen confections of the invention due to their toxicity.

Fruits and other plants produce a number of chemical entities and some of these constituents can be used as drugs of abuse, and are commonly involved in poisoning. Plants containing naturally-occurring hypertensive principles and those with high levels of amine compounds can be antagonistic to antihypertensives. Concurrent use of Aloe juice and/or exudates (commonly used) with Licorice may be potentiated with Aloe.

Toxicity problems have been attributed to the use of the plant Ma-Huang (Ephedra sinica). The present invention, therefore, does not include cardiac glycosides, as associated with Ma Huang and other plant glycosides.

Chart of Toxic Plants and/or Herbs considered Unsafe or
Unfit for Human Use*

| | |
|---|---|
| LICORICE: | Glycyrrhiza glabra |
| Licorice glycosides: | Glycyrrhizin [glycyrrhizic acid] |
| | Potential cardiac arrest and heart failure |
| MA-HUANG: | Ephedra sinica |
| | Illegal in some states. Dysrhythmias occur |
| | with cardiac glycosides. |
| SASSAFRAS: | Sassafras albidium |
| | FDA has prohibited Sassafras as flavors or |
| | food additives |
| POKE ROOT: | Phytolacca Americana |
| Poke Root glycosides: | Triterpenoid saponins |
| | Highly toxic to many organs of the body |

*Partial Chart from The University of Maryland, School of Pharmacy

Compared to sucrose, the sweetness level of the sweetener compositions of the present invention, is 15 times sweeter than sucrose, delivers a significant reduction in calories of 221.2 calories, with only a small dose of fruit sugar (less than 1 gram). This reduction in calories meets the guidelines of an intense, low calorie sweetener.

Calories in Sugar and Sugar Alternatives as Compared to the
Present Invention

| Product | Size | Calories |
|---|---|---|
| Equal (aspartame) | 1 pkt | 4 |
| Sugar Twin saccharin | 1 pkt | 4 |
| Sweet ‘n Low | 1 pkt | 4 |
| Sweet One | 1 pkt | 4 |
| Weight Watchers Sweet'ner | 1 pkt | 4 |
| Brown Sugar, dark | 1 tsp | 16 |
| Sugar, granulated | 1 tsp | 15 |
| Sugar, granulated (.2 oz) | 1 pkt | 23 |
| Domino granulated sugar | 1 pkt | 16 |
| Sugar cubes (½ inch) | 2 cubes | 19 |
| Turbinado sugar | 1 tbsp | 50 |
| Present Invention | 1 packet (½ g) | 1.9 |
| Present Invention | 2 packets (1 g) | 3.8 |

Comparison of Caloric & Sweetness Values of the Present Invention as
Compared to Sugar and Fruit Sugar

| Sweetener | Sweetness Value | Amount | Calories |
|---|---|---|---|
| Sugar, sucrose, | Sugar-sweetness | 80 grams/ | 225.0 |
| table sugar | | 15 teaspoons | |
| Fruit Sugar | 1.7 × sweeter than sucrose | 33 grams/ | 132.4 |
| | | 8 teaspoons | |
| Present | 15 × sweeter than sugar | 1 gram | 3.8 |
| Invention | | | |

Therefore, the sweetener compositions of the present invention provide a benefit, in terms of reducing daily calories consumed, and in using very small doses of fruit sugar instead of large doses. The composition is preferably at least 10 times sweeter than sugar. There is a medical practicality, for diabetics and those watching their caloric intake, in using a natural sweetener that displaces 80 grams of sucrose and 33 grams of fruit sugar per gram of sweetener used.

### Frozen Confections

In certain embodiments, the frozen confections of the invention will include, in addition to a nutritive sweetener, a dairy source, such as heavy cream, half-and-half, whole milk, skim milk, condensed milk, evaporated milk, butter, butter fat, whey, milk solids, non-fat, etc. In certain embodiments, the dairy source will contribute dairy fat and/or non-fat milk solids such as lactose and milk proteins (i.e., whey proteins and caseins). Preferably, the cream contributes dairy fat and/or milk solids to the subject frozen confections. In accordance with one aspect of the invention, a dairy protein powder, such as whey protein, is used as a protein source.

Serum solids or milk solids are used in the frozen confections of the invention to provide the following beneficial organoleptic characteristics: (1) improved texture due to protein functionality; (2) improved body and chew resistance; and (3) decreased snowy or flaky textures. Sources of serum or milk solids for use in the invention include, but are not limited to, condensed whole or skimmed milk (sweetened or non-sweetened); frozen condensed skimmed milk; buttermilk powder or condensed buttermilk; condensed whole milk; superheated condensed skimmed milk; dried or condensed whey; blends of whey protein concentrates, caseinates, and whey powders.

While butter fat from cream and other dairy sources is preferred, alternative fat sources, such as vegetable fat, may be used. For example, fats that can be used in the frozen confections of the invention include, but are not limited to, cocoa butter, illipe, shea, palm, palm kernel, sat, soybean, cottonseed, coconut, rapeseed, canola, and sunflower oils. The amount of fats in frozen confections of the invention is typically from about 1% to 20%. For “low-fat” frozen confections of the invention, the amount of fats present is from about 5% to 10%. For “premium” frozen confections of the invention, the amount of Cats present is from about 15% to about 20%.

According to the subject invention, five factors of great interest in selection of fat source are: (1) the crystal structure of the fat, (2) the rate at which the fat crystallizes during dynamic temperature conditions, (3) the temperature-dependent melting profile of the fat, especially at chilled and freezer temperatures, (4) the content of high melting triglycerides (which can produce a waxy, greasy mouthfeel), and (5) the flavor and purity of the fat (or oil). In certain embodiments, it is important that the fat droplet contain an intermediate ratio of liquid:solid fat at the time of freezing. Although this ratio is dependent on a number of composition and manufacturing factors, embodiments of the invention can comprise ½ to ⅔ crystalline fat at 4-5° C.

Crystallization of fat occurs in three steps: undercoating to induce nucleation, heterogeneous or homogeneous nucleation (or both), and crystal propagation. In bulk fat, nucleation is predominantly heterogeneous, with crystals themselves acting as nucleating agents for further crystallization, and undercooling is usually minimal. However, in an emulsion, each droplet Must crystallize independently of the next. For heterogeneous nucleation to predominate, there must be a nucleating agent available in every droplet, which is often not the case. Thus in emulsions, homogeneous nucleation and extensive undercooling may be common. Accordingly, blends of oils can be used in the frozen confections of the invention, where the oils are selected based on physical characteristics, flavor, availability, stability during storage and cost. Hydrogenation is often necessary to achieve the appropriate melting characteristics. Palm kernel oil, coconut oil, palm oil and fractions thereof, plus their hydrogenated counterparts, can all be used.

Fat from dairy products or non-dairy sources can impart the following organoleptic properties desired in a frozen confection of the invention: (1) increases the richness of flavor; (2) produces a smooth texture by lubricating the palate; (3) and aids in giving body to the frozen confection due to its role in fat destabilization.

If desired, the frozen confection of the invention can include an emulsifying agent and/or stabilizer. If present, the emulsifiers and/or stabilizers are used in the amounts of about 0.1 wt. % to about 0.6 wt. %, preferably 0.2 wt. % to 0.5 wt. %. Typical emulsifying agents for use in accordance with the subject frozen confections include, but are not limited to, phospholipids and proteins (such as dairy or soy proteins), and esters of long chain fatty acids and a polyhydric alcohol. Fatty acid esters of glycerol, polyglycerol esters of fatty acids, sorbitan esters of fatty acids and polyoxyethylene and polyoxypropylene esters of fatty acids may be used but organoleptic properties, of course, must be considered. Monoglycerides and diglycerides may also be used but may also be omitted. Indeed, emulsifiers other than proteins and phospholipids may be omitted.

As understood by the skilled artisan, gum stabilizers are effective in providing certain desired organoleptic properties in frozen confections. For example, gum stabilizers are effective in: controlling viscosity; providing mouth feel; improving whipping (aerating) properties; providing a protective colloid to stabilize proteins to heat processing; modifying the surface chemistry of fat surfaces to minimize creaming; providing acid stability to protein systems; and increasing freeze-thaw stability. Gums can be classified as neutral and acidic, straight- and branched-chain, gelling and non-gelling. The principal gums that may be used in accordance with the subject invention include, but are not limited to, Karaya gums, locust bean gum, carageenan, xanthan gum, guar gum, sodium alginate, gelatin, and carboxymethyl cellulose (CMC).

Various known stabilizers can be included in the low glycemic frozen confections of the invention. For example, a stabilizer that can be added to the frozen confections of the invention is a microcrystalline cellulose as described in U.S. Pat. No. 5,209,942. Microcrystalline cellulose is cellulose crystallite aggregates with a level-off D.P. level off DP is the average level-off degree of polymerization measured in accordance with the paper by O. A. Batista entitled: “Hydrolysis and Crystallisation of Cellulose,” Vol. 42, pages 502 to 507, Industrial and Engineering Chemistry, 1950. An example of microcrystalline cellulose is the water-dispersible cellulose crystallite aggregates described for use in food compositions in British Patent No. 961 398 (Also cf. U.S. Pat. Nos. 2,978,446, 3,157,518 and 3,539,365).

A combination of microcrystalline cellulose and sodium carboxymethyl cellulose may be used in the low glycemic frozen confections of the invention. The microcrystalline cellulose is preferably a material in which the particles are themselves coated with 10 percent (by weight of the material) of sodium carboxymethyl cellulose. The sodium carboxymethyl cellulose used for coating is preferably one of medium viscosity, that is one which, in 1 percent aqueous dispersion, has a viscosity of from 300 to 1000 centipoises at 20° C. In one embodiment, one or any combination of: carboxymethylcellulose (in addition to that with which the microcrystalline cellulose may be coated), xanthan gum, starch and alginate may be used in the low glycemic frozen confections of the invention.

If desired, gelatin (such as 225 bloom) may be included in the subject frozen confections. For example, the low glycemic frozen confections of the invention may include gelatin at levels of about 0.1 wt. % to about 1.0 wt. %, preferably from 0.2 wt. % to about 0.6 wt. %.

Certain salts such as citrates, phosphates, and chlorides may be added to the subject frozen confections to alter the buffering capacity of those compositions and to improve the water binding capacity of proteins and improve solubility and flavor. Sodium chloride and sodium monophosphate at very low levels are preferred but calcium phosphate and particularly monocalcium phosphate may also be employed. Sodium chloride is preferred at levels of 0.05% to 0.3%; and sodium monophosphate is preferred at levels of 0.01% to 0.1%. Tlhe bulking agents employed must have only trace amounts of mono- and disaccharides.

In certain embodiments oF the invention, flavorings are added to the product but only in amounts that impart desired consumer flavors. The flavoring may be any of the commercial flavors employed in ice cream, such as varying types of cocoa, pure vanilla or artificial flavor, such as vanillin, ethyl vanillin, chocolate, extracts, spices and the like. It will further be appreciated that many flavor variations may be obtained by combinations of these basic flavors. The low glycemic frozen confections of the invention are flavored to taste as mentioned above. Suitable flavorants may also include seasoning, such as salt, and real and/or imitation fruit or chocolate flavors either singly or in any suitable combination. Flavorings may also mask any off-tastes from vitamins and/or minerals and other ingredients.

Preservatives such as Polysorbate 80, Polysorbate 65 and potassium sorbate may be used as desired.

In certain embodiments of the invention, the frozen confection is fortified with one or more vitamins and/or minerals and/or fiber sources. These may include any or all of the following:

Ascorbic acid (Vitamin C), Tocopheryl Acetate (Vitamin E), Biotin (Vitamin H), Vitamin A Palmitate, Niacinamide (Vitamin B3), Potassium Iodide, d-Calcium Pantothenate (Vitamin B5), Cyanocobalamin (Vitamin B12), Riboflavin (Vitamin B2), Thiamine Mononitrate (Vitamin B1), Molybdenum, Chromium, Selenium, Calcium Carbonate, Calcium lactate, Manganese (as Manganese Sulfate), Iron (as Ferric Orthophosphate) and Zinc (as Zinc Oxide). The vitamins are preferably present at from 5 to 20% RDI, especially from about 15% RDI. Preferably, Fiber sources are present in the product at greater than 0.5 wt. % and do not exceed 6 wt. %, especially 5 wt. %.

Types of frozen confections prepared in accordance with the subject invention include, but are not limited to, water ices, scoop products, frozen yogurts, ice cream, ice cream prepared as bars (such as chocolate-coated ice cream bars), filled cones (such as individually wrapped wafer cones filled with ice cream and various toppings), adult stick products (such as ice cream presented on a stick), children's novelty products (such as molded water ice products), cups (such as paper or plastic cups containing an individual portion of: ice cream), card tubes (such as water-based frozen fruit snakes contained in cardboard tubes), and single brisquettes (such as small blocks of uncoated ice cream).

Processes used for the manufacture of the frozen confections of the invention are essentially the same as those used for ice cream products. The processes common to all such products include: ingredient blending, freezing, and packaging. In certain embodiments, processes used in the manufacture of the subject frozen confections further include the steps of: filtration, pumping, pasteurization, homogenization, cooking, and aeration. The ingredient blending process involves mixing basic materials for the frozen confections together with water to produce a homogenous mixture of the required flavor. In certain embodiments, a filtration step is applied to remove any foreign matter. In other embodiments, the blended ingredients are subjected to preheating (or cooking) and homogenization to ensure dispersal of fat particles in the mix. In addition, a final heating (or pasteurization) step may be applied to the mix to remove any possible microbiological contamination. After ingredient blending (and any other additional processes) is completed, the mix is passed through a freezing means (such as a freezer). In the freezing means, the mix can be whipped and/or air is injected to provide a desirable texture to the frozen confection. Following the freezing process, the product is packaged for distribution to the consumer.

The frozen confections of the invention can be manufactured by batch or by continuous processes. Ingredients may be either liquid or dry, or a combination of both. Liquid ingredients can be blended by the use of positive metering pumps to a mixing tank or by in-line blending. Dry ingredients must be hydrated during the blending operations. This is most commonly accomplished by the use of turbine mixers in processing vats or by incorporating the dry material through a high speed, centrifugal pump. The blending temperature depends upon the nature of the ingredients, but it must be above the melting point of the fat present and sufficient to fully hydrate gums used as stabilizers and proteins. If batch processing is used, optional vitamins and other minerals may be blended with cold water, mixed well and added to the batch after a portion of the mix has flowed to the high temperature short time (HTST) units. Pasteurization is generally carried out in such high temperature short time units, in which the homogenizer is integrated into the pasteurization system. The protein and microcrystalline cellulose are advisedly fully hydrated before adding other components which might interfere with the hydration.

Following are examples that illustrate advantageous characteristics of an embodiment of the invention. These examples should not be construed as limiting. All percentages are by weight and all solvent mixture proportions are by volume unless otherwise noted.

### EXAMPLE 1

### Research Design and Methods General Methods for Conducting Experiments, as described in Examples 2 and 3

Ten pre-screened humnan subjects were used for each product tested.

White bread is used as the standard. Each subject is fed a minimum of three bread standards for comparison to the products tested. Calculations are made using the area under the curve (AUC) as compared to bread standards (converted to the glucose scale). AUC is calculated using standard protocols.

Fasting blood glucose measurements were made at 15-minute intervals throughout the trial, for 2-4 hours, or until blood glucose levels stabilized. Capillary blood was preferred: the results for capillary blood glucose (BG) were less variable than that of venous plasma glucose. Additionally, elevations in BG were greater in capillary blood than venous plasma, and the differences in Test Foods and bread standards were easier to detect statistically using capillary blood glucose.

When venous blood pressure (VBP) was called for in clinical trials, an overnight fast of 12 h was taken and a blood sampling i.v. cannula was inserted into the antecubital vein. Blood samples were taken at −5, −10 and −15 minutes (analysed as a pool) before the Test Food, and every 15 minutes for the first hour, and every 30 minutes thereafter, to a 5-hour postprandial period.

Taste, mouth-feel, gastrointestinal issues; nausea, flatulence, bloating, were recorded.

Results presented in the experiments were based on the glucose scale. Glycemic index and glycemic load values are converted to the glucose=100 scale by multiplication with the factor 0.7.

Subjects underwent a two-visit protocol, the first to determine glucose tolerance status and the second to measure SI. Subjects fasted for 12 hours before each of the two visits, and abstained from alcohol for 24 hours. Smoking was prohibited on the day of the study.

Anthropometric measures were taken for each subject. Height and weight were measured in duplicate and recorded to the nearest 0.5 cm and 0.1 kg, respectively. BMI was calculated as weight (in kilograms) divided by the square of height (in meters). Waist circumference was measured at the natural indentation or at a level midway between the iliac crest and the lower edge of the rib cage if no natural indentation was visible. Waist was recorded to the nearest 0.5 cm, and the mean of two measures within 1 cm of each other was used.
Waist circumference (cm)
Disposition index
BMI (kg/m²)
Insulin sensitivity (min-1·μU-1·mL-1·10−4)
Fasting insulin (pmol/l)
AIR (μU·ml-1·min-1)

A 2-hour, 75-g oral glucose tolerance test was performed during the first visit, and World Health Organization (WHO) criteria were used to assign glucose tolerance status. Subjects taking oral hypoglycemic medications were classified as type 2 diabetics. Acute insulin response (AIR) and insulin sensitivity (SI) were assessed using a 12-sample, insulin-enhanced, frequently sampled intravenous glucose tolerance test (FSIGT) with minimal model analysis. Modifications of the protocol were used when appropriate for targeted Trials. AIR and fasting insulin were log transformed: logarithmic transformations, the disposition index, typically calculated as the product of AIR and SI, was preferentially created as the sum of log (AIR+20) and log (SI+1).

AIR was calculated based on insulin levels through the 8-min blood samples before insulin infusion. Fasting plasma insulin was determined by radioimmunoassay.

SI was calculated by mathematical modeling methods: the time course of plasma glucose was fit using nonlinear least squares methods with the plasma insulin values as a known input to the system.

Mean glycemic index values were assigned to white bread standard purchased at available grocery stores.

In subject pre-screening, typical glycemic index (GI) and glycemic load (GL) were 58 and 128 g/day, respectively. A higher SI value expressed increased insulin sensitivity, while higher fasting insulin implied increased insulin resistance. Higher AIR indicated greater insulin secretion in response to glucose, and higher disposition index implied increasing pancreatic functionality. Positive in-ear relationships were observed between food/liquid intake and levels of fasting insulin, BMI, and waist circumference.

Adjustments were made for any non-carbohydrate Test Foods using the Residual Method.

Dietary fiber intake and measures of SI, insulin secretion and adiposity were made, including multivariate adjustment and scoring, as dietary fiber in a Test Food is associated with SI, fasting insulin, BMI, and waist circumference. In the subject trials, it was observed that 1 8-10 gram fiber content was associated with lower level of fasting insulin with statistically higher level of SI. A significant linear relationship between glycemic load and outcome levels was observed, that are positive for fasting insulin, BMI, and waist circumference and inverse for SI.

Subject responses to Test Food activation of adipose-tissue fat-storage mechanisms, IE LPL, were tracked and recorded per protocols described herein.

If Cephalic Response testing was included in the protocol, it was recorded during the first 60 seconds after the subjects have mouth-contact with the Test Food, and for 30-second intervals thereafter. Swallow versus non-swallow protocols were utilized for accuracy, as digestion of dietary carbohydrates starts in the mouth, where salivary α-amylase initiates starch degradation.

Venous blood samples for insulin and FFA were collected in glass tubes and allowed to coagulate on ice for 10 min, then stored immediately at −20° C. until analysis.

Blood glucagon samples were taken in Vacutainer-EDTA with Trasylol® added (50 μl/ml of blood), and then plasma was obtained and processed immediately.

Serum glucose was assayed by the glucose oxidase method (Photometric Instrument 4010, Roche, Basel, Switzerland).

### Calculations & Statistical Analysis

Glycemic Index (%)=(carbohydrate content of each food item (g)×GI)/total amount of carbohydrate in meal (g); and

Glycemic Load (g)=(carbohydrate content of each food item (g)×GI)/100.

Area beneath baseline was not utilized.

Serum glucose and insulin postprandial responses were assessed using incremental (iAUC) and total area under the curve (tAUC) at 2 h, 5 h and between 2-5 h. Serum FFA and plasma glucagon postprandial responses were assessed using the tAUC at 2 h, 5 h and between 2-5 h. iAUC and tAUC were geometrically calculated using the trapezoidal method.

### Glycemic Index Definitions

The glycemic index (GI) of a particular food is determined by calculating the incremental area under the blood glucose response curves (iAUC) for that food compared with a standard control of white bread (utilizing the trapezoid rule).

Glycemic Response and Cephalic Response are defined differently, are based on ingestion of Test Foods that have nutrient value, and -0- nutrient value.

Glycemic Response/Impact refers to the effects elicited by oral ingestion of any edible agent (not just carbohydrate foods) on blood glucose concentration and insulin levels during the digestion process.

GI alone is unable to predict the glycemic response/impact when different amounts of carbohydrates are eaten. Glycemic Load (GL) must be utilized in conjunction with GI to differentiate the acute impact on blood glucose and insulin responses induced by Test Foods.

GL is based on a specific quantity and carbohydrate content of the test food. GL is calculated by multiplying the weighted mean of the dietary glycemic index by the percentage of total energy from the test food.

When a test Food contains quantifiable carbohydrates, the Glycemic load equals GI (%)×grams of carbohydrate per serving. One unit of GL approximates the glycemic effect of 1 gram of glucose. Typical diets contain from 60-180 GL units per day.

A high glycemic load diet is defined as: 60% carbohydrate, 20% protein, 20% fat (glycemic load 116 g/1000 kcal). In contrast, a low glycemic load diet is defined as: 40% carbohydrate, 30% protein, 30% fat, (glycemic load 45 g/1000 kcal).

### Glucose Scale

Results presented in the following examples are based on the glucose scale. Glycemic index and glycemic load values were converted to the glucose—100 scale by multiplication with the factor 0.7.

### Example 2

### Affect of Frozen Confection on Glucose Levels

### Materials and Methods

Board Approved Human In Vivo Clinical Studies on Test Food were conducted on an ice cream product manufactured and formulated with Trutina Dulcem® (TD). This Example was conducted to determine the glycemic index, glycemic load, diabetic properties, and adipose tissue fat-storage mechanisms associated with human ingestion of the Test Food.

The TD Ice Cream (also referred to herein as the “Test Food”) was prepared and shipped intact (frozen) to testing facilities. The metabolic response of the Test Food was analyzed during this clinical study. The Test Food was fed to human subjects comprised of non-diabetics, diabetics, and children.

Human subjects were orally fed the Test Food.

Ten-fifteen (10-15) human subjects are typically used in each product tested. White bread is used as the standard. Each subject is fed a minimum of three bread standards for comparison to the products tested.

Calculations are made using the area under the curve (AUC) as compared to bread standards (converted to the glucose scale). AUC is calculated by statisticians using standard protocols. Bread Average Area Under the Curve (AUC) and Test Food AUC were analyzed from serum readings from subjects and converted to the Glucose Scale. Test Food clinical study graphs, calculations, Test Food AUC, pre-screening data, blood draws, analysis, and human subject files/identity are standard in each trial.

The glycemic index (GI) is determined in vivo utilizing standardized clinical protocols. The glycemic potential of each carbohydrate (including sugar alcohols) corresponds to the measure of the triangular surface of the hyperglycemic curve induced by carbohydrate ingestion. Glucose, given an index of 100, represents the triangular surface of the corresponding hyperglycemic curve. The GI of other carbohydrates, therefore, is calculated by the following formula:

$$\frac{Triangular surface of tested carbohydrate}{Triangular surface of glucose} \times 100$$

The GI rises according to the level of hyperglycemia. The higher the GI, the higher the hyperglycemia induced by the carbohydrate.

Glycemic Index is determined from 15-minute interval-blood-draws (serum) of the test subjects for the incremental area under the blood glucose response curve of a specific carbohydrate portion of the Test Food expressed as a percent of the response to the same amount of carbohydrate from a standard food taken by the same subject.

The Incremental Area Under the Curve (AUC) is calculated geometrically (+trapezoid rule) from the clinical data as related to the Test Food, and compared to the actual carbohydrates found in the Test Food.

The glycemic response of a food determines its acceptability for use by overweight and obese persons, diabetics, hypoglycemics, and persons with Insulin Resistance, Metabolic Syndrome, and Syndrome X. Advanced glycemic testing also identifies the ability of a food to stimulate fat-storage in fat cells via stimulation of human fat-storing enzymes and mechanisms, such as Lipoprotein Lipase, Neuropeptide Y, and Leptin.

Glycemic Load is based on a specific quantity and carbohydrate content of the test food. GL is calculated by multiplying the weighted mean of the dietary glycemic index by the percentage of total energy from the test food. When the test food contains quantifiable carbohydrates, the Glycemic Load equals GI (%)×grams of carbohydrate per serving. One unit of GL approximates the glycemic effect of 1 gram of glucose. Typical diets contain from 60-180 GL units per day.

Glycemic response refers to the effects that relate to oral ingestion of any edible agent (not just carbohydrate foods) on blood glucose concentration during the digestion process.

### Results

### Glycemic Index Qualifications

The following guidelines on Glycemic Index and Glycemic Load are those as Accepted by the World Health Organization (WHO) and the Food and Agriculture Organization (FAO).

| Glycemic Index | Glycemic Load |
|---|---|
| Low GI | 55 or less |
| High GI | 70+ |
| Low GL | 10 or less |
| High GL | 20+ |

TABLE 1
Adult Non-Diabetic Humans

| | |
|---|---|
| Number of Subjects (Non-Diabetic) | 10 |
| Test Food | TD Ice Cream (Vanilla) |
| Servings per Subject | One Serving (55 grams) |
| Carbohydrates Per Feeding | 8.7 grams |
| Glycemic Index | Low Glycemic |
| | 21.0 on glucose scale |
| Glycemic Load | Low Glycemic Load |
| | 1.8 |

TABLE 2
Adult Diabetic Humans

| | |
|---|---|
| Number of Subjects (Non-Diabetic) | 10 |
| Test Food | TD Ice Cream (Vanilla) |
| Servings per Subject | One Serving (55 grams) |
| Carbohydrates Per Feeding | 8.7 grams |
| Glycemic Index | Low Glycemic |
| | 24.0 on glucose scale |
| Glycemic Load | Low Glycemic Load |
| | 2.1 |

TABLE 3
Non-Diabetic Children (Ages 6-17 years)

| | |
|---|---|
| Number of Subjects (Non-Diabetic) | 10 |
| Test Food | TD Ice Cream (Vanilla) |
| Servings per Subject | One Serving (55 grams) |
| Carbohydrates Per Feeding | 8.7 grams |
| Glycemic Index | Low Glycemic |
| | 26.0 on glucose scale |
| Glycemic Load | Low Glycemic Load |
| | 2.3 |

As illustrated in Tables 1-3 above, in human adult non-diabetic subjects, the Test Food, TD Vanilla Ice Cream, performed as a Low Glycemic food with a Low Glycemic Load, and did not over-elevate blood glucose or insulin levels, and did not activate human fat-storage in adipose tissue fat-cells via Lipoprotein Lipase, or imbalance Leptin levels. Further, in human adult diabetic subjects, the Test Food, TD Vanilla Ice Cream, performed as a Low Glycemic food with a Low Glycemic Load, and did not over-elevate blood glucose or insulin levels, and did not activate human fat-storage in adipose tissue fat-cells via Lipoprotein Lipase, or imbalance Leptin levels.

In human non-diabetic pre-screened children, the Test Food, TD Vanilla Ice cream, performed as a Low Glycemic food with a Low Glycemic Load, and did not over-elevate blood glucose or insulin levels, and did not activate human fat-storage in adipose tissue fat-cells via Lipoprotein Lipase, or imbalance Leptin levels. In children, The Test Food did not exacerbate ADD or ADHD, and did not cause over-activity in the children tested.

All subjects in the study reported “excellent flavor and texture” for the Test Food. No reports of gastrointestinal distress were noted after consumption of the Test Food.

Results of this clinical study are based solely on the specific Test Food (Trutina Dulcem Ice Cream). During this study, clinical evidence showed that utilizing Trutina Dulcem in place of sucrose, maltodextrins, high fructose corn syrup, sugar alcohols, and other sugars and carbohydrates used in the production of ice cream, resulted in significantly reduced diabetic risk markers, as compared to regular ice cream, including: lower postprandial plasma glucose and insulin profiles; lower plasma triacylglycerol; decreased LPL; and decreased hormone-sensitive lipase mRNA in subcutaneous abdominal adipose tissue (fat).

Following oral consumption of a high glycemic ice cream product, rapid absorption of glucose (early postprandial period) integrated incremental blood glucose concentration can reach a minimum of twice that of a low glycemic index ice cream containing identical nutrients and energy. The resulting hyperglycemic state acts in conjunction with elevated concentrations of the gut hormones glucagon-like peptide-1 and glucose-dependent insulinotropic polypeptide, and stimulates insulin release from pancreatic beta cells while inhibiting glucagon release from alpha cells.

The resulting high insulin-to-glucagon ratio exacerbates the normal anabolic responses to eating, including uptake of nutrients by insulin-responsive tissues, stimulation of glycogenesis and lipogenesis, and suppression of gluconeogenesis and lipolysis.

Following ingestion of a high glycemic ice cream product (middle postprandial period), nutrient absorption from the gastrointestinal tract declines, but the biological effects of the high insulin and low glucagon levels persist. Consequently, blood glucose concentration falls rapidly, often into the hypoglycemic range. The physiological significance of this hypoglycemia is demonstrated by a greater fall in glucose oxidation rate after consumption of a high, compared with a low, glycemic index ice cream product. In terms of human obesity and diabetes, as well as all other insulin-related disorders, dietary control over insulin levels is mandatory. High glycemic ice cream over-elevates insulin levels, thus triggering fat-storage mechanisms in humans, such as Lipoprotein Lipase. Low glycemic ice cream prevents stimulation of adipose tissue fat-storage mechanisms, thus providing greater control over the development and maintenance of obesity and type 2 diabetes.

The value of TD's metabolic role in ice cream is clearly validated as opposed to the use of high glycemic sugars and carbohydrates, such as sucrose, glucose, maltodextrins, high fructose corn syrup, and other typical ice cream ingredients. The use of Trutina Dulcem in ice cream, as a replacement to high glycemic sugars and carbohydrates, reversed the blood glucose/insulin response, and further, did not stimulate adipose-tissue fat-storage via Lipoprotein Lipase (LPL), Leptin and/or Neuropeptide Y imbalance in adults or children.

### Example 3

### Affect of Frozen Confection on Glycemic Index, Glycemic Load, and Adipose

The following experiment was conducted to assess the metabolic response to an ice cream product manufactured and formulated with Trutina Dulcem® (TD) “Test Food”. The product was fed to human diabetics and non-diabetics.

The Test Food was fed to human subjects, and cross analyzed. Bread Average Area Under the Curve (AUC) and Test Food AUC were analyzed from serum readings and converted to the Glucose Scale.

Utilizing standardized clinical protocols, accommodations were made for the low-end carbohydrate products tested. Ten human subjects were used for each product tested. White bread was used as the standard. Each subject was fed a minimum of three bread standards for comparison to the products tested. Calculations were made using the area under the curve (AUC) as compared to bread standards (converted to the glucose scale). AUC was calculated by GS statisticians using standard GS protocols.

### Glycemic Index

The glycemic index of the frozen confection of the subject invention (Test Food) was determined in vivo utilizing standardized clinical protocols. The glycemic potential of each carbohydrate (including sugar alcohols) corresponded to the measure of the triangular surface of the hyperglycemic curve induced by carbohydrate ingestion. Glucose, given an index of 100, represented the triangular surface of the corresponding hyperglycemic curve. The GI of other carbohydrates, therefore, was calculated by the following formula:

$$\frac{Triangular surface of tested carbohydrate}{Triangular surface of glucose} \times 100$$

The GI rose according to the level of hyperglycemia. The higher the GI, the higher the hyperglycemia induced by the carbohydrate.

TABLE 4

| Subjects: 10 | Diabetic Humans |
|---|---|
| Dosage Per Subject: | 1 Serving/105 grams |
| Carbohydrates per Serving: | 22.0 grams per 105 g |
| GLYCEMIC INDEX | LOW GLYCEMIC |
| | 22.0 on glucose scale |
| GLYCEMIC LOAD | LOW GLYCEMIC LOAD |
| | 4.8 |

TABLE 5

| Subjects: 10 | Diabetic Humans |
|---|---|
| Dosage Per Subject: | 2 Serving/210 grams |
| Carbohydrates per Serving: | 44.0 grams per 210 g |
| GLYCEMIC INDEX | LOW GLYCEMIC |
| | 15.0-19.0 on glucose scale |
| GLYCEMIC LOAD | LOW GLYCEMIC LOAD |
| | 8.4 |

TABLE 6

| Subjects: 10 | Non-Diabetic Humans |
|---|---|
| Dosage Per Subject: | 1 Serving/105 grams |
| Carbohydrates per Serving: | 22.0 grams per 105 g |
| GLYCEMIC INDEX | LOW GLYCEMIC |
| | 28.0 on glucose scale |
| GLYCEMIC LOAD | LOW GLYCEMIC LOAD |
| | 6.2 |

TABLE 7

| Subjects: 10 | Non-Diabetic Humans |
|---|---|
| Dosage Per Subject: | 2 Serving/210 grams |
| Carbohydrates per Serving: | 44.0 grams per 210 g |
| GLYCEMIC INDEX | LOW GLYCEMIC |
| | 18.0 on glucose scale |
| GLYCEMIC LOAD | LOW GLYCEMIC LOAD |
| | 7.9 |

### Clinical Assessment:

### Glycemic Status

The Test Food was submitted for independent human in vivo clinical trials. Results of the clinical trial showed the Test Food as listed herein:
Low Glycemic, Low GL in Diabetics per “one serving of 105 grams”
Low Glycemic, Low GL in Diabetics per “two servings of 210 grams”
Low Glycemic, Low GL in Non-Diabetics per “one serving of 105 grams”
Low Glycemic, Low GI in Non-Diabetics per “two servings of 210 grams”

It is clear that the glycemic index of the product tested decreased as serving size increased. This highly unusual property of the Test Food appears to be unique to its specific ingredients, as the glycemic response of similar foods tested elevated as serving size increased.

### Taste & Gastrointestinal Profile

No reports of gastrointestinal distress were noted after consumption of any of the servings used in this clinical study. Subjects reported “excellent flavor and texture” and further stated that the Test Food was the “best ice cream they have ever eaten”.

### Protocols for Adipose Tissue Fat Assessment

Adipose tissue in obesity becomes refractory to suppression of fat mobilization by glycemic and insulin responses, and also to the normal acute stimulatory effect of insulin on activation of lipoprotein lipase (involved in fat storage).

The metabolic relationship between adipose tissue fat-storage and ingested food can be tracked and documented in vivo. Test Foods that increase total Lipoprotein Lipase (LPL) activity, both secreted and cell-associated, promote adipose fat storage in humans.

Lipoprotein lipase (LPL) is a key enzyme regulating the disposal of fuels in the body. LPL is expressed in a number of peripheral tissues including adipose tissue, skeletal and cardiac muscle and mammary gland. In white adipose tissue, LPL is activated in the fed state and suppressed during fasting. The reverse is true in muscle. LPL is the definitive metabolic gatekeeper for fat storage in the fat cell.

Oral consumption of control food (bread) elicited distinct responses in humans. These metabolic responses ranged from glycemic and insulinogenic, to adipose tissue fat storage, and imbalances in human fat-storing mechanisms, such as Lipoprotein Lipase (LPL), Neuropeptide Y, and Leptin.

Foods that activate deposition in human adipose tissue fat cells can be identified and classified as to their fat-storage capacity. Foods that trigger Lipoprotein Lipase (LPL) cause a net effect as adipocytes fill up and reach maximum storage capacity. As this occurs, new adipose tissue fat cells are created to fulfill storage needs. This situation also leads to fat deposition in other tissues. Accumulation of triacylglycerol in skeletal muscles and in liver is associated with insulin resistance.

Obese humans present 70-80% greater body fat than the lean humans. exhibited elevated levels of leptin and insulin and increased activity of Lipoprotein Lipase in adipose tissue (aLPL), with no change in muscle LPL.

Common characteristics of obese humans include hyperphagia, elevated circulating levels of triglycerides (TG), nonesterified fatty acids (NEFA) and glucose, and a significant increase in beta-hydroxyacyl-CoA dehydrogenase (HADII) activity in muscle, reflecting its greater capacity to metabolize fat.

This is typically accompanied by a significant increase in expression of the peptide, galanin (GAL), in the paraventricular nucleus (PVN), as measured by in situ hybridization and real-time quantitative PCR, and also in GAL peptide immunoreactivity. Specific characteristics of obesity, including expression of hypothalamic peptides, are dependent upon diet composition, thus the precise composition of a food determines its fat-storage proclivity. Whereas obesity on an HFD is associated with hyperphagia and elevated lipids, fat metabolism in muscle, and fat-stimulated peptides such as GAL, obesity on an HCD with a similar increase in body fat shows none of these characteristics and instead exhibits a metabolic pattern in muscle that favors carbohydrate over fat oxidation.

The existence of multiple forms of obesity, with different underlying mechanisms, are diet dependent. Adipose Tissue Fat Studies described herein focus on identification of the proclivity and ability of food to stimulate fat-storage in fat cells via stimulation of human fat-storing enzymes and mechanisms. Foods are clinically analyzed in vivo to determine their metabolic fat-storing properties with optional specific focus on insulin-resistance disorders and adipose tissue fat-storage via LPL.

### Human Adipose Tissue Rating Protocols

Foods are rated according to the following percentages in Table 8:

TABLE 8
ADIPOSE TISSUE FAT-STORAGE SCALE

| LEVEL | PERCENT | FAT-STORING CAPACITY | |
|---|---|---|---|
| 1 | 1%-25% | Very Low | Adipose Tissue Fat-Storing |
| | | | Capacity |
| 2 | 25%-49% | Low | Adipose Tissue Fat-Storing |
| | | | Capacity |
| 3 | 50%-60% | Moderate | Adipose Tissue Fat-Storing |
| | | | Capacity |
| 4 | 61%-75% | High | Adipose Tissue Fat-Storing |
| | | | Capacity |
| 5 | 76%-100% | Very | Adipose Tissue Fat-Storing |
| | | High | Capacity |

The frozen confection of the subject invention (Ice Cream Invention) submitted for human in vivo clinical trials. Analysis of the Adipose Tissue Fat-Storing (ATFS) properties revealed a Rating of LEVEL 1 on the ATFS Scale (see above). This ice cream thus shows an extremely low proclivity to store in human fat cells, in diabetics and non-diabetics.

COMPARATIVE ANALYSIS OF THE GLYCEMIC
PROPERTIES OF COMMON FOODS VERSUS
THE TEST FOOD

| | |
|---|---|
| FOOD | GLYCEMIC INDEX |

Non-Diabetics

| | |
|---|---|
| 1 grapefruit | 25 |
| 1 orange | 41 |
| 120 g grapes | 43 |
| 210 g Ice Cream Invention | 18 |
| 1 pear | 38 |
| 1 apple | 33 |
| 50 g Low Fat, Light vanilla ice cream | 50 |
| 50 g Vanilla ice cream | 62 |

All patents, patent applications, provisional applications, and publications referred to or cited herein are incorporated by reference in their entirety, including all figures and tables, to the extent they are not inconsistent with the explicit teachings of the specification.

It should be understood that the examples and embodiments described herein are for illustrative purposes only and that various modifications or changes in light thereof will be suggested to persons skilled in the art and are to be included within the spirit and purview of this application and the scope of the appended claims.

I claim:

1. A frozen confection composition comprising a low glycemic sweetener composition that triggers little or no cephalic phase insulin release, wherein said sweetener consists essentially of kiwi powder, a fruit glycoside, and a fruit sugar.

2. The frozen confection composition of claim 1, wherein the kiwi powder is from Chinese kiwi fruit.

3. The frozen confection composition of claim 1, wherein the fruit glycoside is a triterpene or terpene glycoside.

4. The frozen confection composition of claim 3 wherein the glycoside is a cucurbitane glycoside.

5. The frozen confection composition of claim 1, wherein the fruit sugar is L-fructose.

6. The frozen confection composition of claim 1, wherein the sweetener is present in the composition from about 0.1% to about 20%.

7. The frozen confection composition of claim 1, further comprising any one or more combination of the ingredients selected from the group consisting of: dairy source(s), fat source(s), emulsifying agent(s), stabilizer(s), salt(s), flavoring agent(s), preservative(s), fiber source(s), vitamin(s), and mineral(s).

8. A method of making a frozen confection composition, wherein said method comprises mixing ingredients for making the confection together with a low glycemic sweetener composition that triggers little or no cephalic phase insulin release, wherein said sweetener consists essentially of kiwi powder, a fruit glycoside, and a fruit sugar, together with basic materials; and cooling the mixture.

9. The method of claim 8, wherein the kiwi powder is from Chinese kiwi fruit.

10. The method of claim 8, wherein the fruit glycoside is a triterpene or terpene glycoside.

11. The method of claim 10, wherein the glycoside is a cucurbitane glycoside.

12. The method of claim 8, wherein the fruit sugar is L-fructose.

13. The method of claim 8, wherein the sweetener is present in the composition from about 0.1% to about 20%.

14. The method of claim 8, wherein the ingredients For making the confection is any one or more combination of the ingredients selected from the group consisting of: dairy source(s), fat source(s), emulsifying agent(s), stabilizer(s), salt(s), flavoring agent(s), preservative(s), fiber source(s), vitamin(s), and mineral(s).
